(19) United States
(12) Patent Application Publication
(10) Pub. No.: US 2012/0099760 A1
(43) Pub. Date: Apr. 26, 2012

(54) ASSOCIATING INFORMATION WITH A PORTION OF MEDIA CONTENT

(75) Inventors: Philip Bernosky, Saratoga, CA (US); Claus Bauer, San Francisco, CA (US); Jack Buser, San Francisco, CA (US); Guido Voltolina, Portland, OR (US)

(73) Assignee: Dolby Laboratories Licensing Corporation, San Francisco, CA (US)

(21) Appl. No.: 13/341,836

(22) Filed: Dec. 30, 2011

Related U.S. Application Data
(63) Continuation of application No. 12/198,737, filed on Aug. 26, 2008.
(60) Provisional application No. 60/969,543, filed on Aug. 31, 2007.
(60) Provisional application No. 61/026,446, filed on Feb. 5, 2008.

(51) Int. Cl. G06K 9/00

(52) U.S. Cl. 382/100

(57) ABSTRACT

A media fingerprint is derived from a portion of media content. Information is associated with the media content portion based on the derived media fingerprint. Upon linking to the associated information, the associated content is presented with the media content portion. The media fingerprint includes a unique representation of the media content portion that is derived from a characteristic component of the media content portion. The media content may comprise an original instance of content or a derivative instance of the original content.

### CROSS-REFERENCE TO RELATED APPLICATIONS; BENEFIT CLAIM

This application claims the benefit as a Continuation of application Ser. No. 12/198,737, filed Aug. 26, 2008, which claims priority to U.S. Provisional Patent Appln. No. 60/969,543 filed Aug. 31, 2007, and also claims benefit of U.S. Provisional Patent Appln. No. 61/026,446 filed Feb. 5, 2008, and is related to copending Application Ser. No. ______, filed ______, the entire contents of which is hereby incorporated by reference as if fully set forth herein, under 35 U.S.C. §120. The applicant(s) hereby rescind any disclaimer of claim scope in the parent application(s) or the prosecution history thereof and advise the USPTO that the claims in this application may be broader than any claim in the parent application(s).

### TECHNOLOGY

The present invention relates generally to media. More specifically, embodiments of the present invention relate to associating information with a portion of media content.

### BACKGROUND

Audio and video media comprise an essentially ubiquitous feature of modern activity. Multimedia content, such as most modern movies, includes more than one kind of medium, such as both its video content and an audio soundtrack. Modern enterprises of virtually every kind and individuals from many walks of life use audio and video media content in a wide variety of both unique and related ways. Entertainment, commerce and advertising, education, instruction and training, computing and networking, broadcast, enterprise and telecommunications, are but a small sample of modern endeavors in which audio and video media content find common use.

Audio media include music, speech and sounds recorded on individual compact disks (CD) or other storage formats, streamed as digital files between server and client computers over networks, or transmitted with analog and digital electromagnetic signals. Examples of video media include movies and other recorded performances, presentations and animations, and portions thereof, sometimes called clips. It has become about as familiar to find users watching movies from Digital Versatile Disks (DVD) playing on laptop computers while commuting as at home on entertainment systems or in theaters. Concerts from popular bands are streamed over the internet and enjoyed by users as audio and/or viewed as well in webcasts of the performance. Extremely portable lightweight, small form factor, low cost players of digital audio files have gained widespread popularity. Cellular phones, now essentially ubiquitous, and personal digital assistants (PDA) and handheld computers all have versatile functionality. Not just telecommunication devices, modern cell phones access the Internet and stream audio and video content therefrom and, it is no longer unusual to find game enthusiasts participating in networked video game play and fans watching sporting events therewith.

As a result of its widespread and growing use, vast quantities of audio and media content exist. Given the sheer quantity and variety of audio and video media content that exist, and the expanding growth of that content over time, an ability to identify content is of value. Media fingerprints comprise a technique for identifying media content.

Media fingerprints are unique identifiers of media content from which they are derived, extracted or generated. The term “fingerprint” is aptly used to refer to the uniqueness of these media content identifiers, in the sense that human beings are uniquely identifiable, e.g., forensically, by their fingerprints. While similar to a signature, media fingerprints perhaps even more intimately and identifiably correspond to the content. Audio and video media may both be identified using media fingerprints that correspond to each medium.

Audio media are identifiable with acoustic fingerprints. An acoustic fingerprint is generated from a particular audio waveform as code that uniquely corresponds thereto. Upon generating an acoustic fingerprint, the corresponding waveform from which the fingerprint was generated may thereafter be identified by reference to its fingerprint. The acoustic fingerprints may be stored, e.g., in a database. Stored acoustic fingerprints may be accessed to identify, categorize or otherwise classify an audio sample to which it is compared. Acoustic fingerprints are thus useful in identifying music or other recorded, streamed or otherwise transmitted audio media being played by a user, managing sound libraries, monitoring broadcasts, network activities and advertising, and identifying video content (such as a movie) from audio content (such as a soundtrack) associated therewith.

The reliability of an acoustic fingerprint relates to the specificity with which it identifiably corresponds with a particular audio waveform. Some audio fingerprints provide identification so accurately that they may be relied upon to identify separate performances of the same music. Moreover, some acoustic fingerprints are based on audio content as it is perceived by the human psychoacoustic system. Such robust audio fingerprints thus allow audio content to be identified after compression, decompression, transcoding and other changes to the content made with perceptually based audio codecs; even codecs that involve lossy compression (and which may thus tend to degrade audio content quality). Analogous to identifying audio media content by comparison with acoustic fingerprints is the ability to identify video media with digital video fingerprints.

Video fingerprints are generated from the video content to which they correspond. A sequence of video information, e.g., a video stream or clip, is accessed and analyzed. Components characteristic of the video sequence are identified and derived therefrom. Characteristic components may include luminance, chrominance, motion descriptors and/or other features that may be perceived by the human psychovisual system. The derived components are compressed into a readily storable and retrievable format.

Video fingerprints are generated using relatively lossy compression techniques, which render the fingerprint data small in comparison to their corresponding video content. Reconstructing original video content from their corresponding video fingerprints is thus typically neither practical nor feasible. As used herein, a video fingerprint thus refers to a relatively low bit rate representation of an original video content file. Storing and accessing the video fingerprints however is thus more efficient and economical

Stored video fingerprints may be accessed for comparison to a sample of a video sequence, which allows accurate identification of the video content in the sequence. Video fingerprints are thus useful for accurately identifying video content for a user as the content is viewed, as well as in authoritatively managing copyrights, and in validating authorized, and detecting unauthorized, versions and instances of content being stored, streamed or otherwise used. As with many acoustic fingerprints moreover, video fingerprints are perceptually encoded. Thus the content of the video sequence may be accurately identified by comparison to video fingerprints after compression, decompression, transcoding and other changes to the content made with perceptually based video codecs; even codecs that involve lossy compression (and which may thus tend to degrade video content quality).

Audio and video media content may be conceptually, commercially or otherwise related in some way to separate and distinct instances of content. The content that is related to the audio and video content which may include, but is not limited to other audio, video or multimedia content. For instance, a certain song may relate to a particular movie in some conceptual way. Other example may be text files or a computer graphics that relate to a given speech, lecture or musical piece in some commercial context. However, it may not be easy to ascertain the existence of some content that may be related to particular media content, much less to access the related content in association with the media content.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts a flowchart for an example procedure, according to a possible embodiment of the present invention;

FIG. 2 depicts an example system, according to a possible embodiment of the present invention;

FIG. 3 depicts a flowchart for an example method, according to a possible embodiment of the present invention;

FIG. 4 depicts a flowchart for another example procedure, according to a possible embodiment of the present invention; and

FIG. 5 depicts an example computer system platform, with which a possible embodiment of the present invention may be implemented.

### DESCRIPTION OF EXAMPLE EMBODIMENTS

Associating information with a portion of media content is described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

Example embodiments are described herein according to the following outline:
1.0 General Overview
2.0 Example Procedures
3.0 Example System
4.0 Example Methods
5.0 Example Computer System Platform
6.0 Brief Synopsis
7.0 Equivalents, Extensions, Alternatives, and Miscellaneous

### 1.0 General Overview

Example embodiments described herein relate to associating information with a portion of media content. A media fingerprint is derived from a portion of media content. Information is associated with the media content portion based on the derived media fingerprint. Upon linking to the associated information, the associated information content is presented with the media content portion. As used herein, the terms “associated information,” “associated information content,” and “associated content” may be essentially used synonymously, and the terms “auxiliary information,” “auxiliary associated information,” and “auxiliary content” may refer essentially to the associated information.

As used herein, the term “medium” (plural: “media”) may refer to a storage or transfer container for data and other information. As used herein, the term “multimedia” may refer to media which contain information in multiple forms. Multimedia information files may, for instance, contain audio, video, image, graphical, text, animated and/or other information, and various combinations thereof. As used herein, the term “associated information” may refer to information that relates in some way to information media content. Associated information may comprise, for instance, auxiliary content.

As used herein, the term “media fingerprint” may refer to a representation of a media content file, which is derived or extracted from characteristic components thereof. Media fingerprints are derived (e.g., extracted, generated, etc.) from the media content to which they correspond. As used herein, the term “acoustic fingerprint” may refer to a media fingerprint that may be associated with audio media with some degree of particularity (although an acoustic fingerprint may also be associated with other media, as well). As used herein, the term “video fingerprint” may refer to a media fingerprint associated with video media with some degree of particularity (although a video fingerprint may also be associated with other media, as well). Media fingerprints used in possible embodiments herein may correspond to audio, video, image, graphical, text, animated and/or other media information content, and/or to various combinations thereof, and may refer to other media in addition to media to which they may be associated with some degree of particularity. Media fingerprints, as described herein, may conform essentially to media fingerprints as described in U.S. Provisional Patent Application Nos. 60/969,543 and 61/026,446, which have been incorporated herein by reference for all purposes as if fully set forth herein.

An acoustic fingerprint, for example, may comprise unique code that is generated from an audio waveform, which comprises the audio media content, using a digital signal processing technique. Also for example, a video fingerprint may comprise a unique digital video file, the components of which are derived (e.g., generated, written, extracted, and/or compressed from characteristic components of video content. Derived characteristic components of video content that may be compressed to form a video fingerprint corresponding thereto may include, but are not limited to, luminance values, chrominance values, motion estimation, prediction and compensation values, and the like. Thus, while media fingerprints described herein represent the media content from which they are derived, they do not comprise and (e.g., for the purposes and in the context of the description herein) are not to be confused with metadata or other tags that may be associated with (e.g., added to or with) the media content. Media fingerprints may be transmissible with lower bit rates than the media content from which they are derived. As used herein, the terms “deriving,” “generating,” “writing,” “extracting,” and “compressing,” and the like may thus relate to obtaining media fingerprints from media content portions. These and similar terms may thus relate to a relationship of media fingerprints to source media content thereof or associated therewith. In a possible embodiment, media content portions are sources of media fingerprints and media fingerprints essentially comprise unique components of the media content. For instance, video fingerprints may be derived from (e.g., comprise at least in part) values relating to chrominance and/or luminance in frames of video content. The video fingerprint may also (or alternatively) comprise values relating to motion estimation, prediction or compensation in video frames, such as motion vectors and similar motion related descriptors. Media fingerprints may thus function to uniquely represent, identify, reference or refer to the media content portions from which they are derived. Concomitantly, these and similar terms herein may be understood to emphasize that media fingerprints are distinct from meta data, tags and other descriptors, which may be added to content for labeling or description purposes and subsequently extracted therefrom. In contexts relating to derivative media content, the terms “derivative” or “derive” may further relate to media content that may represent or comprise other than an original instance of media content.

As used herein, the term “auxiliary content,” in relation to a multimedia or other media content file may refer to a piece of information that is indexed by a certain part of the media content file. The auxiliary information itself may not necessarily be identical, or even approximate, to any part of the multimedia itself. For example, a certain portion of a particular video file may index the temperature in a certain location, e.g., New York City, at a certain day or time. The New York City temperature is thus auxiliary content to that part of the video. In another example, a certain portion of a given video file may index a certain model and manufacturing year of a certain model of a particular car manufacturer.

Indexing may be done when an original media file, e.g., a whole movie, is created. However, a possible embodiment provides a mechanism that enables the linking of a segment of video to auxiliary content during its presentation, e.g., upon a movie playback. A possible embodiment functions where only parts of a multimedia file are played back, presented on different sets of devices, in different lengths and formats, and/or after various modifications of the video file. Modifications may include, but are not limited to, editing, scaling, transcoding, and creating derivative works thereof, e.g., insertion of the part into other media.

As used herein, the term “link”, “linked”, and “linking” may refer to storing pointer(s) to auxiliary content in a repository such as a database or list of media fingerprints, storing file name(s) of file(s) that contain auxiliary content in a repository such as a database or list of media fingerprints, storing Universal Resource Locator(s) of location(s) that contain auxiliary content in a repository such as a database or list of media fingerprints, storing database reference(s) that contain auxiliary content in a repository such as a database or list of media fingerprints, storing auxiliary content in a repository such as a database or list of media fingerprints, etc. As used herein, the term “links” may refer to retrieving auxiliary content from pointer(s) stored in a repository such as a database or list of media fingerprints, retrieving auxiliary content from file(s) referred to by a repository such as a database or list of media fingerprints, retrieving auxiliary content using Universal Resource Locator(s) stored in a repository such as a database or list of media fingerprints, retrieving auxiliary content from database reference(s) stored in a repository such as a database or list of media fingerprints, retrieving auxiliary content from a repository such as a database or list of media fingerprints, etc.

A possible embodiment allows identification of auxiliary content that was assigned to a specific part of a media file when the whole media product was created, even when the file is played back in parts, sequences, and modified forms. Moreover, a possible embodiment functions without metadata and thus does not require the insertion generation or other operations with metadata related to the content or any modification of the content. Embodiments function with media of virtually any type, including video and audio files and multimedia playback of audio and video files and the like.

Information such as auxiliary content is associated with media content. In a possible embodiment, media fingerprints such as audio and video fingerprints are used for identifying media content portions. Media fingerprinting identifies not only the whole media work, but also the exact part of the media being presented, e.g., currently being played.

In a possible embodiment, a database of media fingerprints of media files is maintained. Another database maps specific media fingerprints, which represent specific portions of certain media content, to associated auxiliary content. The auxiliary content may be assigned to the specific media content portion when the media content is created. Upon the media content portion's presentation, a media fingerprint corresponding to the part being presented is compared to the media fingerprints in the mapping database. The comparison may be performed essentially in real time, with respect to presenting the media content portion.

For example, a part of a movie may be played on a video related webpage. A media fingerprint corresponding to the part being played is derived therefrom essentially in real time. The media fingerprint is compared to the fingerprints in the mapping database. Upon identification, e.g., to which part of any movies in the mapping database the part being played back belongs, auxiliary content originally or otherwise assigned to this part of a movie is identified and linked to or retrieved.

A possible embodiment allows an advertiser to “purchase,” in a sense, a scene of a video. A vendor or an agent thereof (such as a search engine or a web services provider) may thus choose to associate an advertisement for a product, service or the like with a certain media content portion. For example, a soft drink company could identify a scene where an actor is drinking a specific product of their company. The soft drink company or its agent may purchase rights to use the media fingerprint corresponding to that scene to associate their advertisement with that particular media content portion. Thus, upon presenting that scene to a viewer, information associated with that media content portion is linked to and the soft drink company's advertisement is presented, essentially in real time with respect to the scene playing.

The advertising content may be presented next to, proximate to, or overlaid on the video scene. Whenever this specific part of the movie is presented on virtually any media presentation device connected to the Internet or another network facilitating the embodiment, the part of the movie is identified using the media fingerprint technology. Thus, the purchaser and the associated information play-back webpage are informed. Depending on an exchange agreement between the purchaser and the media content provider or other entity presenting the media content, a related advertisement, defined by the purchaser, is shown in real time with or after the corresponding media content portion is presented.

Moreover, a possible embodiment presents the auxiliary information or other associated information faithfully when the corresponding media content portion is presented, even if the corresponding media content portion is used in derivative content, such as a trailer, an advertisement, or even an unauthorized copy of the media content, pirated for example, for display on a social networking site. In whatever format the media content portion is presented, it is recognized and linked to information associated therewith, such as the auxiliary content. In a possible embodiment, a portion of media content is used in a search query.

In a possible embodiment, a computer system performs one or more features described above. The computer system includes one or more processors and may function with hardware, software, firmware and/or any combination thereof to execute one or more of the features described above. The processor(s) and/or other components of the computer system may function, in executing one or more of the features described above, under the direction of computer-readable and executable instructions, which may be encoded in one or multiple computer-readable storage media and/or received by the computer system.

In a possible embodiment, one or more of the features described above execute in a decoder, which may include hardware, software, firmware and/or any combination thereof, which functions on a computer platform. The computer platform may be disposed with or deployed as a component of an electronic device such as a TV, a DVD player, a gaming device, a workstation, desktop, laptop, hand-held or other computer, a network capable communication device such as a cellular telephone, portable digital assistant (PDA), a portable gaming device, or the like. One or more of the features described above may be implemented with an integrated circuit (IC) device, configured for executing the features. The IC may be an application specific IC (ASIC) and/or a programmable IC device such as a field programmable gate array (FPGA) or a microcontroller.

### 2.0 Example Procedures

The example procedures (and methods) described herein may be performed in relation to associating information with a portion of media content. Procedures that may be implemented with a possible embodiment may be performed with more or less steps than the example steps shown and/or with steps executing in an order that may differ from that of the example procedures. The example procedures may execute on one or more computer systems, e.g., under the control of machine readable instructions encoded in one or more computer readable storage media, or the procedure may execute in an ASIC or programmable IC device.

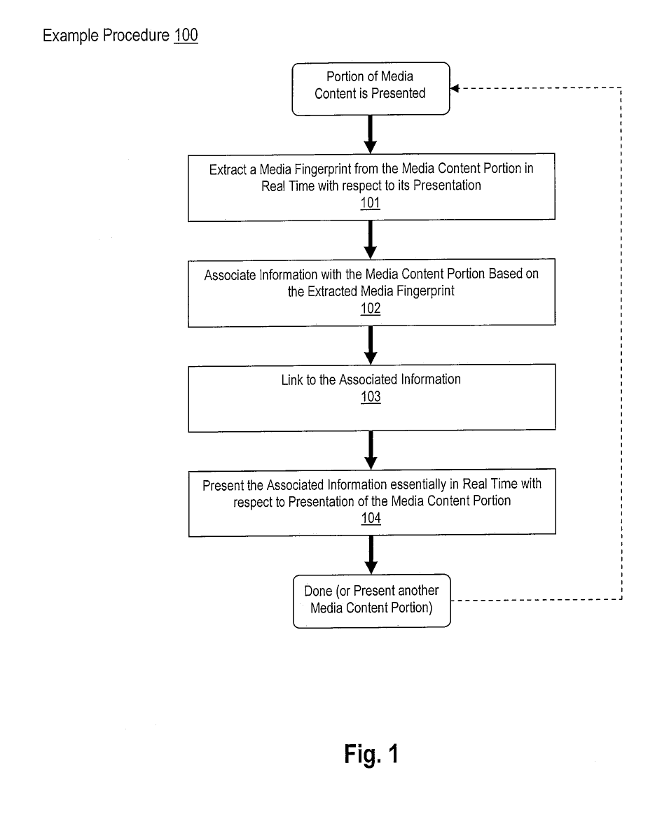

FIG. 1 depicts a flowchart for an example procedure 100, according to a possible embodiment. Procedure 100 relates to associating information with a portion of media content. Initially, the portion of media content, such as a song or a part of a song on an album or other collection of songs, or a certain part of movie, is presented. For example, the media portion is presented as a user is listening to the song or viewing the movie in a video format.

In step 101, a media fingerprint is derived from the media content portion, essentially in real time with respect to the presentation of the media content portion. The media content portion may have a particular temporal length (e.g., of a certain time duration, a given number of film or video frames, etc.). In an implementation for instance, a media content portion may comprise a six second long segments of a video. The media fingerprint may be an acoustic fingerprint for audio media or a video fingerprint for video media. In some cases, an acoustic fingerprint may be derived from a portion of video media content and vice versa; a video fingerprint may be derived from a portion of audio content. The media fingerprint may be derived from other media, such as image, graphical, text, and animation related media, as well as from audio and video media. In some cases, more than one media fingerprint may be derived from a portion of multimedia content.

Prior to extracting the media fingerprint from the media content portion, other functions may occur. For instance, the media content portion being presented, from which the media fingerprint is to be derived, is accessed.

In step 102, information content is associated with the media content portion based on the derived media fingerprint. The information content may be auxiliary or ancillary information that relates in some conceptual or commercial way with the media content portion. The information content may be indexed to the media content portion, for instance, upon creation of the original media content of which the portion comprises a component. The information content may be stored in a repository such as a database, may include video, audio, textual, graphical, haptic or other content, and may include commercial, advertising, instructional, informative or other content associated with the media content portion. For clarity, the term “auxiliary information” may be used hereinafter in referring to the information associated with a media content portion.

In step 103, a link is made to the associated information. Prior to associating the information with the media content portion and linking to the associated information, other functions may occur. For instance, the derived media fingerprint may be compared to a repository such as a database of multiple stored media fingerprints, matched thereto and thus identified. Associating the information and linking thereto may be based on the comparison, match and corresponding identification of the media fingerprint.

In step 104, the information that is associated with the media content portion is presented therewith. For instance, the associated information may be presented essentially in real time with respect to the presentation of the media content portion. The associated information may be presented in conjunction with the media content portion, for example, in a display field adjacent (or otherwise proximate) to a display field in which the media content portion is presented, or overlaid, superimposed, or inset with respect thereto.

Thus for example, a hypothetical movie (e.g., media content) contains a scene (e.g., content portion) in which a star actor enters and drives a certain make and model sports car, or drinks from a particular brand of beverage. Auxiliary information may be associated with this scene that may include an advertisement for the certain make and model sports car or the beverage. As the scene plays, a link to the advertisement is provided. The media player, with which the scene is presented, thus links to the advertisement and presents the advertisement during the scene, in a display field proximate to the display field in which the scene is playing, or may superimpose the advertisement content over the scene, perhaps consciously apparent to a viewer or perhaps presented thereto subliminally.

In addition to advertisements, the auxiliary information associated with the media content may include other commercial information. For example, a hypothetical training video (e.g., media content) for engineers, mechanics, physicians, or technicians may include a segment (e.g., content portion) in which an instructor, a teacher, professor or narrator demonstrates the function of a certain instrument, device, apparatus, component, chemical, solution, tool or the like. Auxiliary information may be associated with this segment that may include commercial information related to the instrument, tool, etc.

Moreover, auxiliary information associated with the media content may include content that is informative in some manner or context with respect to the media content portion. For example, a hypothetical movie (e.g., media content) may be a screen adaptation from a work of classic literature, such as William Shakespeare's Titus Andronicus or Johann Wolfgang von Goethe's Faust, or a movie or video that has achieved classic status or other special significance in cinematography, such as Gone with the Wind, Casablanca, or Apocalypse Now. A particular scene (e.g., content portion) of the movie may have some special literary or other artistic merit.

For example, the character Aaron's soliloquy, upon discovering his child in Titus Andronicus may be thought by literati to have special and perhaps enduring literary and dramatic (perhaps even spiritual) significance. During a presentation of a movie adaptation of Titus Andronicus in a hypothetical educational or literary setting, a scene is presented that includes a part of Aaron's famous soliloquy. Auxiliary information content may include a video, audio or text based commentary by a professor of literature, English or drama, or a theatrical critic or commentator that bears upon Aaron's soliloquy, and is thus associated with the scene being presented. Upon associating this auxiliary information with the scene and linking thereto, the commentary may be presented with the scene.

The association with and link to the associated auxiliary information may be made in real time with the presentation of the scene. The presentation of the auxiliary information may be made in real time and proximate to the media content portion as well. To keep from distracting viewers and listeners of so acclaimed a soliloquy with the commentary related thereto however, real time presentation of the auxiliary content associated therewith may include simply a text or graphics based symbol that signifies the availability of the auxiliary information. The symbol that signifies the availability of the auxiliary information may allow the full commentary to be presented in real time, e.g., upon receiving an input. Alternatively, the presentation of the auxiliary content may be delayed and presented, e.g., after the scene is presented, or the scene may be viewed first with only a symbol that the commentary is available and then repeated with the commentary presented contemporaneously therewith.

Media content that have portions to which such informative auxiliary information may be associated are not limited to literary and other artistic works but may sound in virtually any field. For instance, media content may include recordings of scientific symposia, classroom lessons, political campaigns, speeches, debates, town hall meetings, legal and government proceedings, and the like. Auxiliary information that may be associated with media content may thus include also include instructional, educational, aesthetic, contextual, and analytic information. Such auxiliary associated information may include commentary or criticism related to the media content portion. Alternative information may also be associated with the media content portion, for example, in the context of political campaigning. Auxiliary information associated with such media content may thus contrast with or contradict the media content portion, or include comparison thereto and augmentation and substantiation thereof.

Upon presenting the associated information with the media content portion, procedure 100 may continue (or restart) as another media content portion is presented or accessed. Alternatively, procedure 100 may be complete upon presenting the associated information with the media content portion.

The media content portion and its component parts portions may include original media content. A part of a media content portion may also include derivative content. Derivative content may be derived from the media content portion with an item of content that is independent with respect to the original instance of the media content. Derivative content may include a media sequence related to the original media content, such as an audio sample taken from a part of a song or a movie trailer taken from a scene of a video. Derivative content may be an authorized copy of original media content.

For example, song samples and video trailers may be used to respectively advertise music and movies by an enterprise that owns the media and/or is engaged in marketing the media. However, possible embodiments function even with derivative content that are not authorized, such as unauthorized copies of original content that are pirated. Thus, the auxiliary information is associated and linked to even from unauthorized copies of pirated media content portions.

Moreover, the media content and portions thereof may include content that is modified with respect to an original instance (e.g., version, etc.) of the media content. The media content that has been scaled, edited, transcoded, scaled converted, reformatted, or the like, or modified by combinations of such modifications.

### 3.0 Example System

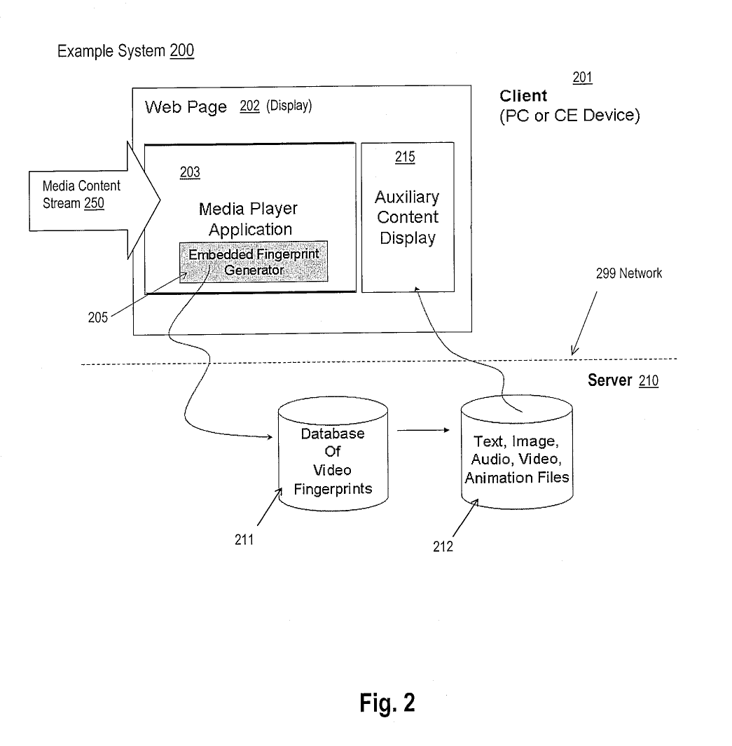

FIG. 2 depicts an example system 200, according to a possible embodiment. System 200 functions in relation to associating information with a portion of media content. System 200 may thus execute a process, perform a procedure, or otherwise function to associate information with a portion of media content. In a possible embodiment, system 200 performs a procedure for associating information with a portion of media content such as procedure 100, described above with reference to FIG. 1.

A portion of system 200 may be configured with one or more components of a computer system, which may operate under control of instructions that are encoded with computer readable storage media. A portion of system 200 may also be configured with an ASIC or a programmable IC device. Portions of system 200 may be disposed within a network capable media player or decoder and information repositories such as one or more databases. One or more repositories may be disposed integrally with, proximate to, or remote from other components of system 200, including the media player or decoder and/or another repository. Some components of system 200 may be coupled to other components thereof via one or more networks, which may include the Internet.

System 200 has a client computer 201. Client computer 201 may be a workstation, a personal computer (PC), or a consumer electronic (CE) device such as a TV, DVD player, stereo music system, home theater system or the like. Client 201 is communicatively coupled, directly or via one or more networks 299, with one or more servers 210. (Alternatively, one or more of servers 210 may be implemented with another client computer, e.g., another PC or CE device.) One or more of the servers 210 may be an Internet server. One or more of the servers 210 may be a database server.

A stream 250 of media content is accessed (e.g., received, downloaded, or played back from a DVD, CD or other content recording) by client 201. Portions (e.g., six second segments) of the media content of stream 250 are decoded by a media player application 203. Media player application 203 presents the decoded portions on a web page or other presentation capable display 202. Media player application 203 may present the media content portions sequentially with respect to media content stream 250 as a whole, although their presentation may be disjoint with respect to the order with which some of the portions are decoded.

Media player application 201 has an embedded media fingerprint generator (e.g., extractor) 205. Fingerprint generator 205 periodically extracts media fingerprints from media content stream 250. In a possible embodiment, one or more media fingerprints are derived from media content stream 250 for every portion of the media content therein and in real time with respect to presentation of that portion. In an implementation, media content portions are six second long. However, the media content portions with which media fingerprints correspond may be of virtually any temporal length, which may be measured according to time duration, a number of frames, or the like, and which may be variable from one section of portions of content stream 250 to another.

Upon extraction from the portions of stream 250, each of the media fingerprints is compared to multiple stored media fingerprints in a repository 211 thereof, such as a media fingerprint database. (While video fingerprints are discussed for example, possible embodiments are well suited to function with any kind of media fingerprints.) Fingerprint repository 211 may comprise a data storage component of client 201, a storage component that is proximate to or local with respect to client 201 and/or communicatively coupled thereto essentially directly, or a storage repository remote from client 201 and communicatively coupled therewith via one or more of networks 299.

Matching a media fingerprint derived from a portion of media content stream 250 to one of the media fingerprints stored in media fingerprint repository 211 allows identification of media content stream 250 and the portion thereof from which the matched fingerprint was derived. The identified media content portion is compared to a repository 212 such as a database of information content, including multiple audio, video, image, graphics, text, animation files, and combinations of multiple media files. Repository 212 may comprise a component of repository 211 or may be separate or independent therefrom and proximate to or local with respect to repository 211 or remote therefrom.

Repository 212 may be communicatively coupled essentially directly with repository 211 or communicatively coupled therewith via one or more of networks 299. With respect to one another, repositories 211 and 212 may comprise identical, similar, or different information storage types. Either or both of repositories 211 and 212 may comprise a database, a file system, a storage area network (SAN), network area storage (NAS) or network based virtual storage.

Upon the comparison and search for a match between the identified media fingerprint derived from the portion of stream 250 and information content stored in repository 212, a match may be found. The matching content is associated with the portion of stream 250 as auxiliary information content 215 in relation thereto. Media player application 203 links to the associated auxiliary content 215. Media player application 203 presents the auxiliary content 215 in real time with respect to the presentation of the portion of stream 250 associated therewith. The associated (e.g., auxiliary) content 215 is displayed alongside, over, superimposed on, or otherwise proximate to or in conjunction with the corresponding portion of stream 250 on the web page or other display 202.

### 4.0 Example Methods

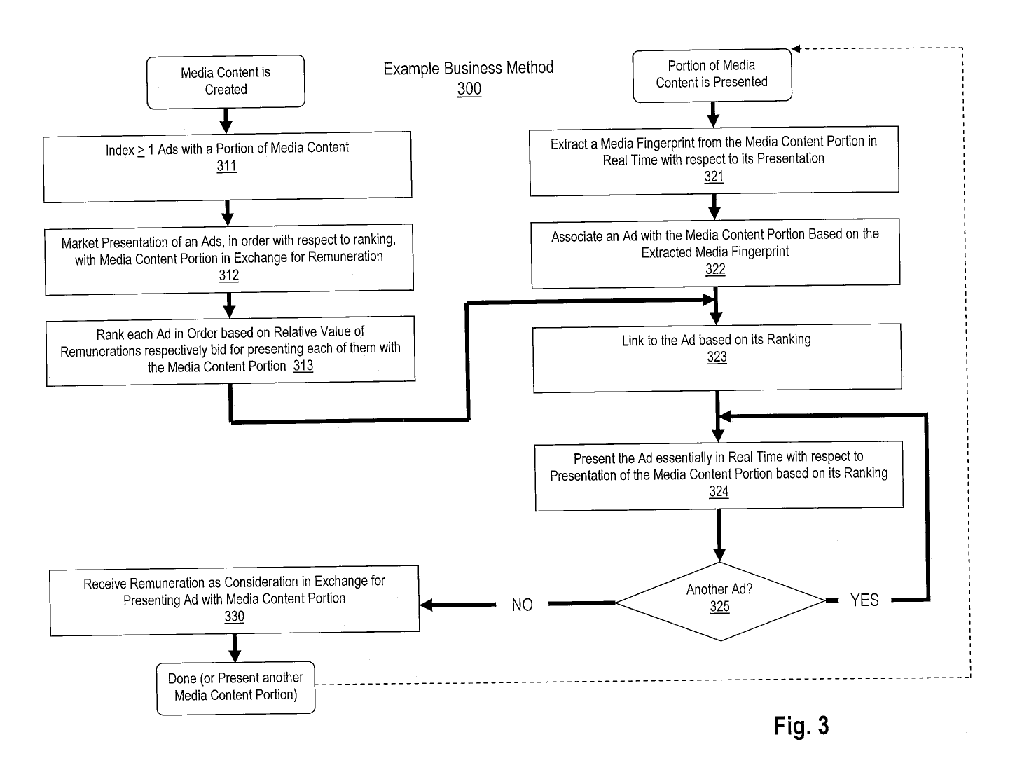

Procedures and systems described herein may be used for conducting business operations such as may relate to sales and presentation of advertising and instruction and the presentation of commercial and educational information. FIG. 3 depicts a flowchart for an example method 300, according to a possible embodiment. Upon creation of media content, one or more advertisements (“Ads”) are indexed in step 311 with a portion thereof.

In step 312, presentation of the advertisements in exchange for valuable consideration such as remuneration, revenue or the like, is marketed with the media content portion. For example, the advertisements may be marketed to entities that may want to associate an advertisement related to their product or service, with the media content portion. Where more than one advertisement is associated with a single media content portion, each of the advertisements may be ranked in an order.

In step 313 therefore, each of the advertisements is ranked in an order that is based on the relative values of the remuneration, which were respectively offered (e.g., bid) for presenting them with the media content portion. For example, a first price value is greater than a second price value. A first advertisement from a first entity, which bids the first price value for associating the first advertisement with the media content portion, is ranked higher in the order than a second advertisement from a second entity, which bid the lower second price value for associating the second advertisement with the media content portion.

Upon presentation of the media content portion, a media fingerprint is derived from the media content portion in step 321. The media fingerprint is derived in real time with respect to the presentation of the corresponding media content portion. In step 322, one or more advertisements are associated with the media content portion, based on the media fingerprint derived therefrom.

In step 323, a link is made to one or more of the advertisements, based on their respective rankings. In step 324, the advertisement to which a link is established is presented essentially in real time with respect to the presentation of the media content portion.

In step 325, it is determined whether another advertisement is associated with the media content portion. If so, step 324 is repeated for the other advertisement. Other advertisements may be selectively or sequentially displayed with the media content portion, based on their respective rankings.

If no other advertisements are associated with the media content portion, or upon presentation of all or a given number of the other advertisements associated therewith, remuneration is received in step 330, e.g., upon notification, billing, debiting, invoicing or the like of the entities that have agreed to have their advertisements presented with the media content. Method 300 may now be complete or may repeat upon presentation of another media content portion.

Other methods may relate to providing instruction, education, or training, providing a forum for commentary, or providing commercial information in exchange for remuneration. In these methods, instructional, educational, or technical information, commentary, concurrence, debate and dissent, and commercial information are respectively associated with media content. Upon presentation of a certain media content portion, a particular item of the associated (e.g., auxiliary) information is provided and remuneration is received in exchange therefore.

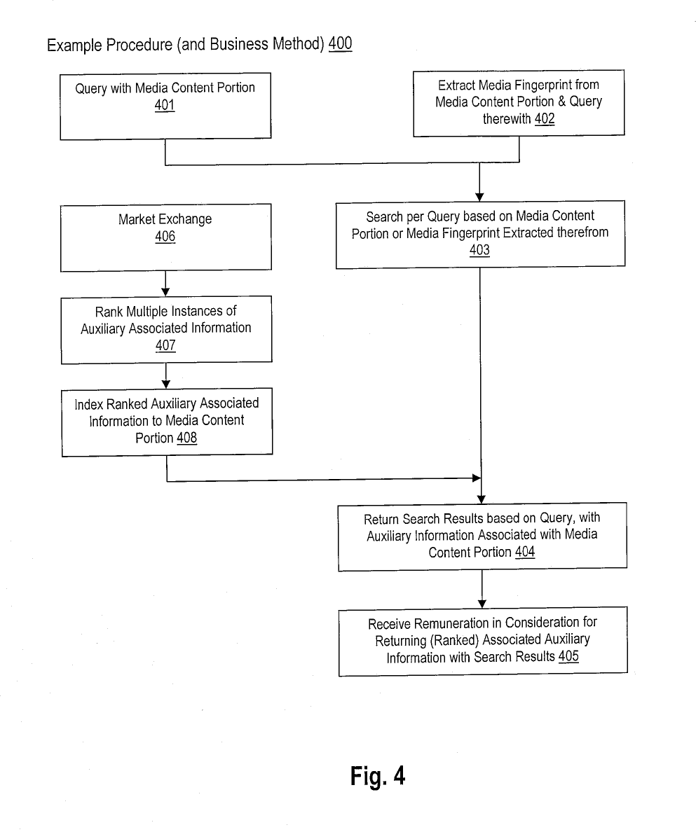

FIG. 4 depicts a flowchart for another example procedure 400, according to a possible embodiment. In step 401, media content or a portion thereof comprises a query input to a search engine. In another possible embodiment, a media fingerprint is derived in step 402 to form a query input. Querying with a media fingerprint input may conserve bandwidth, e.g., in comparison to using raw media content or a portion thereof, from which the media fingerprint is derived, as a query input. In step 403, a search engine performs a search for information relating to the media fingerprint or the media content or portion thereof. The search may thus be performed based on a media fingerprint derived from the media content or portion. The search may be performed across multiple information repositories such as databases and a virtual database comprising the contents of the Internet. In step 404, auxiliary information associated with the media content portion may be presented with the search results returned in response to the query.

Either of these possible embodiments may be used for searching libraries, databases, or other repositories of media content for particular media segments or other portions of media content. Upon returning search results in response to queries that include portions of media content or media fingerprints derived therefrom, information that is associated with the media content portion is presented with the search results.

Moreover, another method may be related to procedure 400. For instance, in step 405, valuable consideration is received in exchange for returning the auxiliary associated information with the search results. The exchange may be marketed in step 406. Multiple instances of auxiliary associated information may exist. In step 407, the multiple instances may be ranked. In a possible embodiment, the ranking may be based on the value of remuneration agreed to in exchange for linking to and/or providing the auxiliary information with the search results. In step 408, the ranked auxiliary associated information may be indexed to the media content portion and/or search results.

### 5.0 Example Computer System Platform

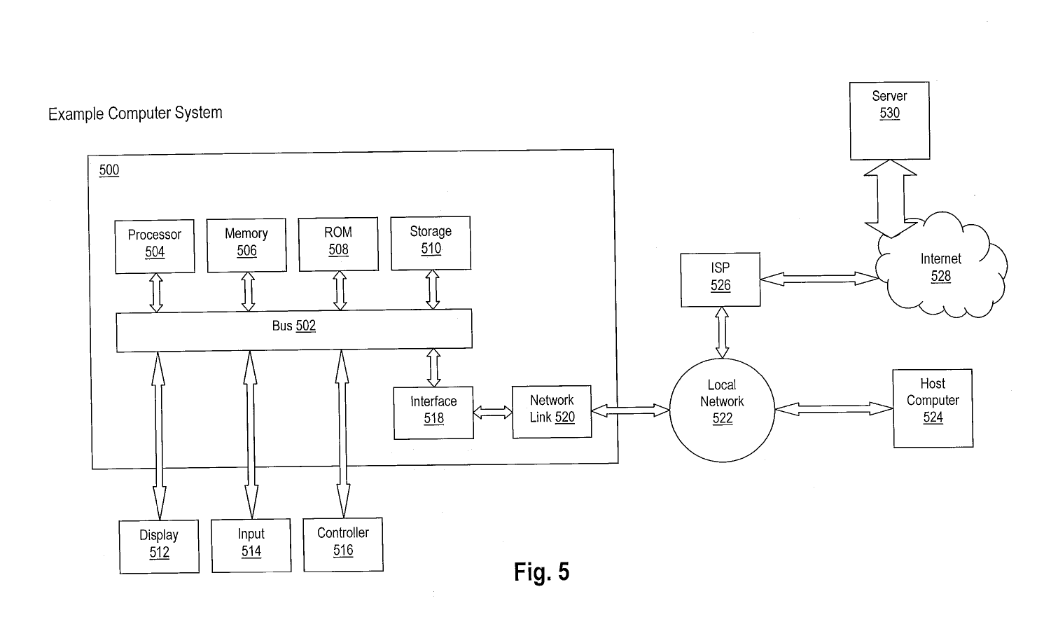

FIG. 5 depicts an example computer system platform 500, with which a possible embodiment may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a liquid crystal display (LCD), cathode ray tube (CRT) or the like, for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for associating information with a portion of media content. According to one possible embodiment, rewriting queries with remote objects is provided by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement the invention. Thus, possible embodiments are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and other conductors and fiber optics, including the wires that comprise bus 502. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other legacy or other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a digital subscriber line (DSL), cable or other modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. In accordance with the invention, one such downloaded application provides for associating information with a portion of media content, as described herein.

The received code may be executed by processor 504 as it is received, and/or stored in storage device 510, or other non-volatile storage for later execution. In this manner, computer system 500 may obtain application code in the form of a carrier wave.

### 6.0 Brief Synopsis

To recap some parts of the description above, associating information with a portion of media content is described. This brief synopsis presents a brief, simplified recap for providing a basic review of some aspects of embodiments of the present invention described above. It should be noted that this synopsis is not an extensive summary of aspects of the embodiment. Moreover, it should be noted that this synopsis is not intended to be understood as identifying any particularly significant aspects or elements of the described embodiments, nor as delineating any scope of the described embodiments in particular, nor of the invention in general. The following brief synopsis merely reviews some concepts that relate to the example embodiments described in a condensed and simplified format. The synopsis should be understood as merely a brief, round, conceptual recap of the description of example embodiments, above.

Information is associated with a portion of media content. A media fingerprint is derived from a portion of the media content. The media fingerprint includes a unique representation of the media content portion from which it is extracted that is derived from a characteristic component of the media content portion. The information is associated with the portion of media content based on the derived media fingerprint and the associated information is linking to. The associated information content is presented with the portion of media content.

The media content and the portion thereof may include original content. The media content and the portion thereof may also include derivative content, which is derived from the media content portion with at least one item of content that is independent from an original instance of the media content. The derivative content may include a sequence of media content that is related to the original instance of media content, an authorized copy of the original instance of the media content and/or an unauthorized copy of the original instance of the media content.

The media content or the portion thereof may include content that is modified with respect to an original instance of the media content. The modified content is modified with respect to an original instance of the media content with editing, scaling and/or transcoding operations thereon, as well as with compression and decompression (including with somewhat lossy compression techniques).

Associating information with a media content portion may also involve accessing the media content portion, in which the media fingerprint is derived upon accessing the media content portion. The derived media fingerprint is compared with multiple media fingerprints stored in a database or another repository and matched with one of them. Based on matching the derived media fingerprint with one of the multiple stored media fingerprints, the media content portion is identified. Associating the information with the media content portion and/or linking to the associated information is based on matching the derived media fingerprint with one of the multiple stored media fingerprints and/or identifying the media content portion based on the match.

Associating information with a media content portion may also involve presenting the media content portion. The media fingerprint may be derived essentially in real time with respect to presenting the media content portion. Moreover, linking to the associated information may be performed essentially in real time with respect to the presenting the media content portion and the associated content may be presented essentially in real time with respect to presenting the media content portion with which it is associated. The auxiliary content may be indexed to the media content portion, for instance, upon original production of the media content. The media content may include video, audio, or image related media content, as well as textual, graphical or animation related content.

The associated information may have an ancillary or an auxiliary relationship to the media content portion. The associated information may include video, audio, textual, graphical, or haptic content. The associated information may relate to an advertisement and/or to other commercial information.

Associating information with a media content portion may further involve providing the associated information content and receiving valuable consideration in remuneration, in exchange for providing the associated information content, and may also include the marketing of such an exchange. The associated information may include multiple independent instances of associated content. Associating information with media content may thus also involve ranking the multiple independent instances of associated content. The associated content may be provided based on the ranking. The ranking of the multiple independent instances of associated content may be based on a value associated with the remuneration received or offered in consideration for the exchange.

Thus, associating information with a media content portion may include a number of methods. A method may thus relate to associating an advertisement with a media content portion. Associating an advertisement with media content may include extracting a media fingerprint from a media content portion. Based on the derived media fingerprint, advertising content is associated with the portion media content and a link to the advertising content is made. The advertising content is presented, essentially in real time, with the portion of media content and, in an exchange for linking to the advertising content and/or the presentation thereof, valuable consideration is received in remuneration. The exchange may be marketed, e.g., sold, offered for sale, or the like.

The advertising content may include multiple independent instances of advertising content. The method may include ranking the multiple independent instances of advertising content. Linking to the advertising content may include selectively linking to one or more of the multiple independent instances of advertising content based on their respective rankings. The rankings may be based, at least in part, on a value, e.g., financial or monetary, associated with the remuneration.

The associated information may include other commercial information and/or instructional information. Instructional information content may include, but is not limited to, educational information, aesthetic information, contextual information, analytic information, commentary, or criticism, which relates to the media content portion, and/or alternative information, e.g., which relates to the media content portion by way of contrast, comparison, augmentation, substantiation and/or contradiction. Another method may thus relate to associating commercial and/or instructional information with a media content portion. Associating commercial and/or instructional information with a media content portion may include extracting a media fingerprint from a media content portion. The commercial/instructional information is associated with the media content portion based on the derived media fingerprint. The commercial/instructional information is linked to and is presented, essentially in real time, with the media content portion. In exchange for linking to and/or presenting the commercial/instructional information, valuable consideration is received in remuneration. The exchange may be marketed.

A network operable system may associate content-relatable information with a media content portion. The system may include one or more information repositories, such as databases, which are communicatively connected with the network. An information repository stores the content-relatable associated information. An information repository also stores information for correlating multiple media content portions with multiple media fingerprints. A client computer device communicatively connected to the network has one or more processors. The client's processors are configured to extract a media fingerprint from the media content portion. A server is communicatively connected with the network. The server has one or more processors. The server's processors are configured to associate the content-relatable associated information with the media content portion based on the derived media fingerprint, and to link the client computer to the associated content-relatable information. The associated content is presented, at the client computer device, essentially in real time with the media content portion.

A possible embodiment uses a computer readable storage medium that has encoded instructions which, when executed by one or more processors, cause the computer to associate information with a media content portion, for performing at least part of one or more of the methods, processes, procedures, methods or the like described herein and/or to configure a system as described herein.

In a possible embodiment, information is associated with a media content portion. A link is made to the associated information and the associated content is presented with the portion of media content. However, the present embodiment performs these functions without using metadata associated with the media content portion.

A possible embodiment allows searching for information that relates to media content. A repository of information, such as a database, is queried using the media content, a portion thereof, or a media fingerprint derived therefrom. Search results are returned based on the query and a link is made to information associated with the media content portion. The associated information is returned along with the search results.

In a possible embodiment, a method allows remuneration to be received in valuable consideration for linking to the associated information and returning the associated information with the search results. Multiple instances of information associated with the media content portion may be ranked, e.g., based on a value associated with the remuneration bid or otherwise offered in exchange for returning each of the multiple instances with the search results. The exchange may be marketed.

### 7.0 Equivalents, Extensions, Alternatives and Miscellaneous

Associating information with a portion of media content is thus described. In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for associating an advertisement with media content, comprising:
deriving a media fingerprint from a portion of the media content wherein the media fingerprint comprises a unique representation of the media content portion that is derived from a characteristic component of the media content portion;
associating advertising content with the portion of media content based on the derived media fingerprint;
linking to the advertising content wherein the advertising content is presented with the portion of media content; and
in an exchange for the linking step, receiving consideration in a remuneration.

2. The method as recited in claim 1, further comprising:
marketing the exchange.

3. The method as recited in claim 1 wherein the advertising content comprises a plurality of independent instances of advertising content, the method further comprising:
ranking the independent instances of advertising content within the plurality thereof;
wherein the linking to the advertising content step comprises selectively linking to one or more of the independent instances of advertising content based on the ranking step; and
wherein the ranking step is based, at least in part, on a value associated with the remuneration.

4. The method as recited in claim 3 wherein the value associated with the remuneration relates to at least one of a financial or a monetary value corresponding to the remuneration.

5. A system operable in a network for associating content-relatable information with media content, comprising:
one or more information repositories communicatively coupled with the network;
wherein at least one of the information repositories stores the content-relatable information;
wherein at least one of the information repositories stores information for correlating a plurality of media content portions with a plurality of media fingerprints; and
wherein a client computer device, having one or more processors that are configured to derive a media fingerprint from a portion of the media content, is communicatively coupleable with the network;
a server communicatively coupled with the network and having one or more processors, which are configured to:
associate the content-relatable information with the portion of media content based on the derived media fingerprint; and
link the client computer to the associated content-relatable information;
wherein the associated content is presented, at the client computer device with the portion of media content.
